(19) United States
(12) Patent Application Publication
(10) Pub. No.: US 2003/0070634 A1
(43) Pub. Date: Apr. 17, 2003

(54) Axial piston rotary power device

(76) Inventor: Osama M. Al Hawaj, Mubark Al Kabeer (KW)

Correspondence Address: DAVID KIEWIT, 5901 THIRD ST SOUTH, ST PETERSBURG, FL, 33705, US

(21) Appl. No.: 10/017,980

(22) Filed: Dec. 13, 2001

Related U.S. Application Data
(63) Continuation-in-part of application No. 09/977,633, filed on Oct. 15, 2001.

(51) Int. Cl. F02B 75/18

(52) U.S. Cl. 123/56.1

(57) ABSTRACT

An axial piston rotary power device can be configured as a four-cycle and two-cycle internal combustion engine, a compressor, a pump, a fluid-driven motor or an expander. The device includes an external stator housing, an internal axial stator and a rotary cylindrical block attached to an end shaft that can rotate within the annular enclosure formed by the two stators. The cylindrical block contains a plurality of cylindrical cavities arranged as pairs of working cylinders. Each cylindrical cavity encloses a double-acting piston assembly comprising two piston heads connected to a middle portion having a pair of axially spaced apart roller cam followers that make roller contact with a guide cam surface protruding from the inside of the external stator housing. The action of the cam roller followers on the guide cam imparts rotation to the cylindrical block when the piston assemblies reciprocate within their respective bores.

### CROSS REFERENCE TO RELATED APPLICATIONS

This application is a continuation-in-part of the inventor's U.S. Ser. No. 09/977,633 filed on Oct. 15, 2001.

### BACKGROUND OF THE INVENTION

1. Field of the Invention

The invention relates to axial piston rotary power device having one or more pistons disposed parallel to and displaced from an axis of rotation. More particularly, the invention relates to internal combustion engines, pumps, compressors, expanders, fluid driven motors, compressor driven internal combustion engines, and fluid driven compressors. It additionally relates to any such devices that differ in a simple structural modification of a central cylindrical stationary member, cam profile and end plate ports.

2. Background Information

This invention relates to rotary power devices of the type having a plurality of cylinders arranged around and parallel to a central axis of rotation in an equally-spaced relationship, and in which pistons disposed within the cylinders cooperate with a cam track to impart rotational motion to a rotor when the pistons reciprocate in their respective cylinders. Examples of rotary devices of the above type can be found in United States patent specifications such as U.S. Pat. Nos. 5,813,372 of Manthey, U.S. Pat. No. 4,287,858 of Anzalone; Re. No. 30,565 and U.S. Pat. No. 4,157,079 of Kristiansen; U.S. Pat. No. 5,209,190 of Paul; U.S. Pat. No. 5,103,778 of Usich, Jr.; U.S. Pat. No. 5,253,983 of Suzuki, et al.; U.S. Pat. No. 5,323,738 of Morse; U.S. Pat. No. 4,213,427 of Di Stefano; and U.S. Pat. No. 1,614,476 of Hutchinson. Although such power devices have been proven to be theoretically functional, they are characterized in some respects by complexities associated with the arrangements of cams and of intake and discharge means, which make them costly to manufacture, assemble, and maintain. Furthermore, the apparatus of the present invention represents one or more improvements over a device described in the inventor's pending U.S. patent application Ser. No. 09/977,633, filed on Oct. 15, 2001, the disclosure of which is herein incorporated by reference.

### BRIEF SUMMARY OF THE INVENTION

An axial piston rotary power device of the invention comprises a stator portion and a rotor portion having a rotatable shaft extending along an axis of the device. The stator portion of the device comprises an external stator portion defining a generally cylindrical interior bounded by a back plate portion and a front plate portion that has a central throughhole within which the rotatable shaft is journaled. A middle portion of the external stator is preferably formed from a pair of diagonally-split mating elements. In addition, the stator comprises a cylindrical internal stator portion projecting from the back plate portion into the cylindrical interior along the axis of the device so as to define an annular space extending between the internal and external stator portions. The internal stator portion has a plurality of passageways within it, each of the passageways comprising a channel parallel to the axis and each of the channels communicating with at least one respective radially oriented port formed in the internal stator at a respective selected axial position. Yet another static portion of a preferred device is an axially undulating guide track surface that may comprise a surface protruding inwardly, by a predetermined amount, from the annular internal wall of the middle portion of the external stator of the device.

The rotor portion of the device comprises a cylindrical block having a medial annular cutout portion extending through its outer surface so as to form an annular recess. The block is fixedly attached to the shaft and rotatable within the annular space between the internal stator portion and the external stator portion and is arranged so that a protruding guide track surface attached to or forming a portion of the middle portion of the external stator fits into the annular cutout. This block has a central cylindrical bore adapted to receive the internal stator, and also includes a predetermined number of cylindrical cavities parallel to the axis of the device and spaced apart from that axis by a single selected radial distance. Each of the cylindrical cavities is divided into a pair of working cylinders axially separated from each other by a portion of the annular cutout. Each of these cylindrical cavities has a radially inwardly directed end opening adjacent each of its two ends. One of these end openings is associated with a working cylinder in the first set thereof and may communicate with the central cylindrical bore at a first selected axial position. The other end opening in each cylindrical cavity is associated with the associated working cylinder of the second set and may communicate with the central cylindrical bore at a second selected axial position. Alternatively, working cylinders of the first set may comprise respective end openings communicating with the central bore at one selected axial position, and working cylinders of the second set may comprise axial end openings communicating with passages formed in one of the end plates of the external stator.

It will be recognized that either working cylinder arrangement can be described in terms of two sets of working cylinders aligned parallel to the axis of the device, wherein each of the sets comprises a circular array and wherein each cylinder in one set is axially aligned with a respective one of the working cylinders in the other set.

In addition, the annular surface of the cutout portion of the cylindrical block may include an equal number of axial cam grooves extending between ones of each pair of working cylinders. In an operating configuration, each pair of axially opposed working cylinders slidably receives a respective piston assembly. Each of the piston assemblies comprises two opposed cylindrical piston heads fixedly coupled by a middle portion which preferably comprises a pair of axially spaced apart roller cam followers receiving the protruding cam guide. In addition, the middle portion of the piston assembly preferably includes a detachable cam pin follower slidably engaging the cam groove. All of the roller cam followers engage the undulating protruding guide surface so as to couple a rotary motion of the block to the reciprocating translational motions of the pistons. If the pistons are driven to and fro within the cylinders by known means such as the expansion of an explosive air-fuel charge, or by the introduction of a pressurized working fluid, the rotary power device of the invention can function as an internal combustion engine, a fluid-driven compressor, a compound internal combustion and compressor, a fluid-driven motor or expander device providing output shaft power. Conversely, if the block is rotated by the application of a torque to the input shaft, the rotary power device of the invention can function as a pump or compressor.

One embodiment of the present invention provides an improved spark ignition rotary internal combustion engine which operates in a four-cycle mode and which overcomes problems presently encountered in the class of rotary engine having pistons positioned parallel to each other around a common axis of rotation. Another embodiment of the present invention provides an improved rotary internal combustion engine which operates in a two-cycle mode and which overcomes problems presently encountered in the class of rotary engine having pistons positioned parallel to each other around a common axis of rotation.

Another feature of a preferred rotary power device of the invention is that it can be easily converted to a different type of rotary power device by a simple modification or replacement of a central stationary member, cam profile or front end plate. Thus, one can convert an internal combustion engine of the invention into a rotary power device that can act as any one of a pump, a compressor, a fluid-driven pump, a fluid-driven compressor, a fluid-driven motor and an internal combustion-driven compressor

A preferred embodiment of the invention provides a rotary power device having valveless ports.

A feature of some embodiments the invention is that they are light in weight, small in size and have a reduced part count when compared with prior art rotary power devices.

A benefit of some embodiments of the invention is that they provide a rotary power device that closely approximates continuous intake, compression, combustion and discharge processes.

Another benefit of some embodiments of the invention is that they provide a rotary power device characterized by reduced noise and vibration.

Although it is believed that the foregoing recital of features and advantages may be of use to one who is skilled in the art and who wishes to learn how to practice the invention, it will be recognized that the foregoing recital is not intended to list all of the features and advantages. Moreover, it may be noted that various embodiments of the invention may provide various combinations of the herein before recited features and advantages of the invention, and that less than all of the recited features and advantages may be provided by some embodiments.

### BRIEF DESCRIPTION OF THE SEVERAL VIEWS OF THE DRAWING

FIG. 1 is an exploded isometric view of a four-cycle rotary power device.

FIG. 2 is an isometric view of a four-cycle rotary power device of FIG. 1 having quarter portions cut away from the rotor and an external stator for purposes of illustration.

FIG. 3 is an isometric view of the rotor-piston assembly of the rotary power device of FIG. 1, the view having portions cut away for purposes of illustration.

FIG. 3a is an isometric view of an alternative rotor-piston assembly of the rotary power device of FIG. 1 having portions cut away for purposes of illustration

FIG. 4 is an exploded isometric view of the cam and external stator of the four-cycle rotary power device of FIG. 1 having the upper cam portion cut away for purposes of illustration.

FIG. 4a is an exploded isometric view of the cam and external stator of the four-cycle rotary power device employing the alternative rotor-piston assembly of FIG. 3a and having the upper cam portion cut away for purposes of illustration.

FIG. 5 is an isometric view of the internal stator of the rotary power device of FIG. 1 functioning as a four-cycle internal combustion engine.

FIG. 5s is a side elevation view of the internal stator of FIG. 5.

FIG. 5a is a sectional view taken along line 5a-5a of FIG. 5s.

FIG. 5b is a sectional view taken along line 5b-5b of FIG. 5s.

FIG. 6 is an exploded isometric view of the piston assembly of the rotary power device of FIG. 1.

FIG. 7 is an isometric view of rotary power device of FIG. 1.

FIG. 7s is a side elevation view of the rotary power device of FIG. 7.

FIG. 7e is an end view of the rotary power device of FIG. 7.

FIG. 8 is a sectional view taken along line 8-8 of FIG. 7e.

FIG. 9a is a sectional view taken along line 9a-9a of FIG. 7s.

FIG. 9b is a sectional view taken along line 9b-9b of FIG. 7s.

FIG. 10 is an isometric view of an alternative internal stator of the rotary power device of FIG. 1, the device operating as a four-cycle pump, four-cycle compressor, four-cycle fluid-driven motor or four-cycle expander device.

FIG. 10s is a side elevation view of the alternative internal stator of FIG. 10.

FIG. 10a is a sectional view taken along line 10a-10a of FIG. 10s.

FIG. 10b is a sectional view taken along line 10b-10b of FIG. 10s.

FIG. 10c is an isometric view of an alternative internal stator of the rotary power device of FIG. 1 employing the rotor-piston assembly of FIG. 3a and the external stator of FIG. 4a, the device operating as a compound four-cycle internal combustion engine or fluid compressor device.

FIG. 10d is an isometric view of an alternative internal stator of the rotary power device of FIG. 1 employing the rotor-piston assembly of FIG. 3a and the external stator of FIG. 4a, the device operating as a four-cycle fluid-driven compressor device.

FIG. 10e is an isometric view of an alternative front end plate of the alternative external stator of FIG. 4a functioning as internal combustion-driven or fluid-driven compressor device.

FIG. 10f is an end view of the alternative front end plate of FIG. 10e.

FIG. 11 is an isometric view of an alternative two-cycle rotary power device operating as an internal combustion engine, the view having an portion of the rotor and external casing cut away for purposes of illustration.

FIG. 11a is an isometric view of an alternative two-cycle rotary power device operating as a compound internal combustion engine or a compressor, the view having portions of the rotor and external casing cut away for purposes of illustration

FIG. 12 is an isometric view of a rotor-piston assembly of the rotary power device of FIG. 11, the view having portion of rotor cut away for purposes of illustration.

FIG. 12a is an isometric view of rotor-piston assembly of the rotary power device of FIG. 11a, the view having portions of the rotor cut away for purposes of illustration

FIG. 13 is an exploded isometric view of an alternative cam and external stator for a two-cycle power device, the view having a portion cut away for purposes of illustration.

FIG. 13a is an exploded isometric view of an alternative cam and external stator for a two-cycle power device, the view having a portion cut away for purposes of illustration.

FIG. 14 is an isometric view of the rotary power device of FIG. 11.

FIG. 14s is a side elevation view of FIG. 14.

FIG. 14e is an end view of the rotary power device of FIG. 14.

FIG. 15 is a sectional view taken along line 15-15 of FIG. 14.

FIG. 16a is a sectional view taken along line 16a-16a of FIG. 14s.

FIG. 16b is a sectional view taken along line 16b-16b of FIG. 14s.

FIG. 17 is an isometric view of the internal stator of the rotary power device of FIG. 11.

FIG. 17s is a side elevation view of the device of FIG. 17.

FIG. 17a is a section view taken along line 17a-17a of FIG. 17s.

FIG. 17b is a section view taken along line 17b-17b of FIG. 17s

FIG. 17c is a section view taken along line 17c-17c of FIG. 17s

FIG. 17d is a section view taken along line 17d-17d of FIG. 17s

FIG. 17e is a section view taken along line 17e-17e of FIG. 17s.

FIG. 18 is an isometric view of an alternative internal stator of the rotary power device of FIG. 11, the device operating as two-cycle pump, compressor, fluid-driven motor or expander device.

FIG. 18s is a side elevation view of FIG. 18.

FIG. 18a is a sectional view taken along line 18a-18a of FIG. 18s.

FIG. 18b is a sectional view taken along line 18b-18b of FIG. 18s.

FIG. 18c is a sectional view taken along line 18c-18c of FIG. 18s.

FIG. 19 is an isometric view of the front plate of the rotary power device of FIG. 11a.

FIG. 19e is an end view of the front plate of FIG. 19.

FIG. 20a is an alternative isometric view of an internal stator of the rotary power device of FIG. 11a, the device operating a compound two-cycle compressor and internal combustion

FIG. 20b is an alternative isometric view of an internal stator of the rotary power device of FIG. 11a, the device operating as fluid driven compressor.

### DETAILED DESCRIPTION OF THE INVENTION

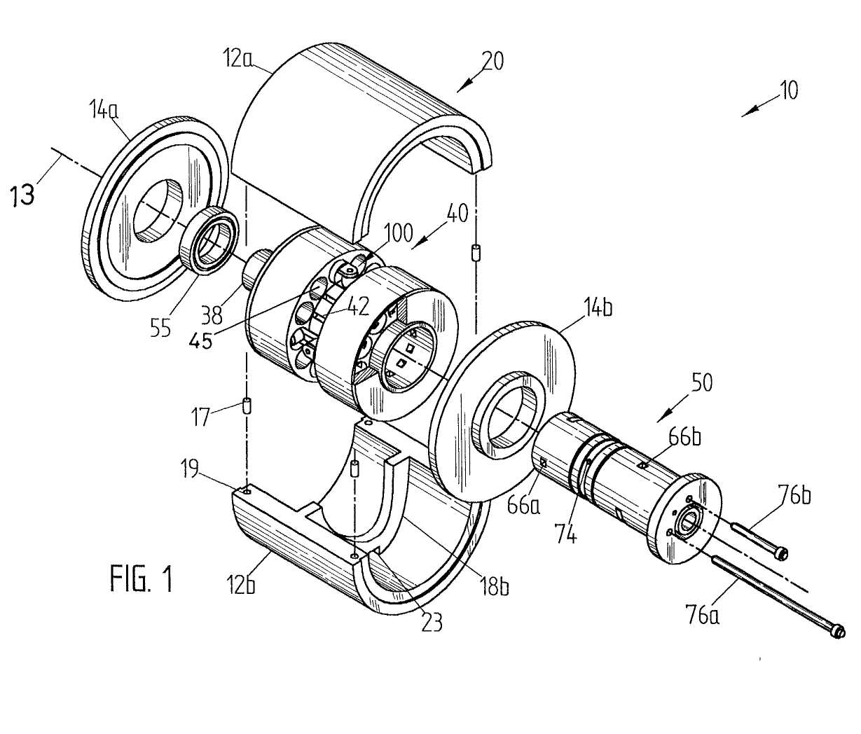

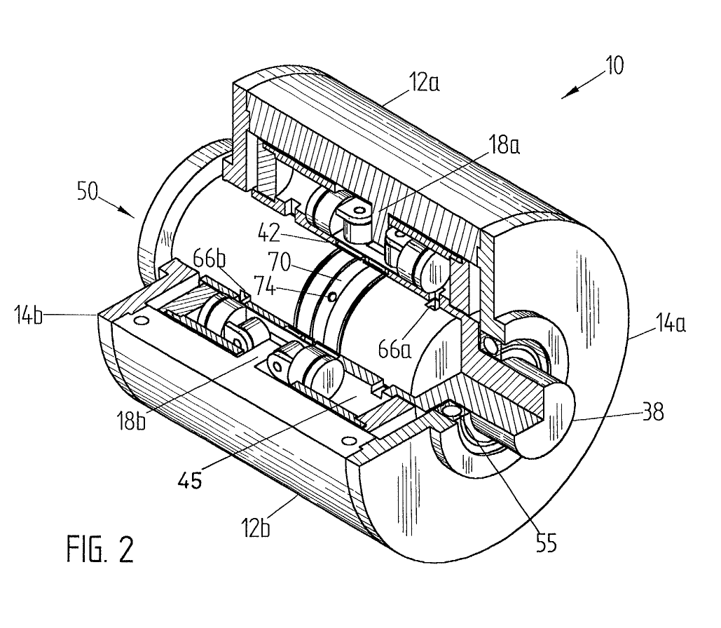

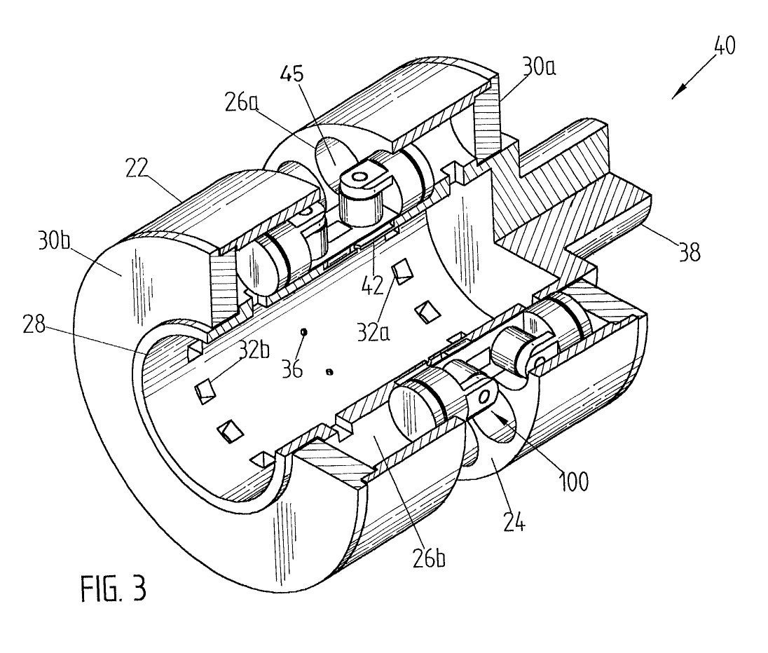

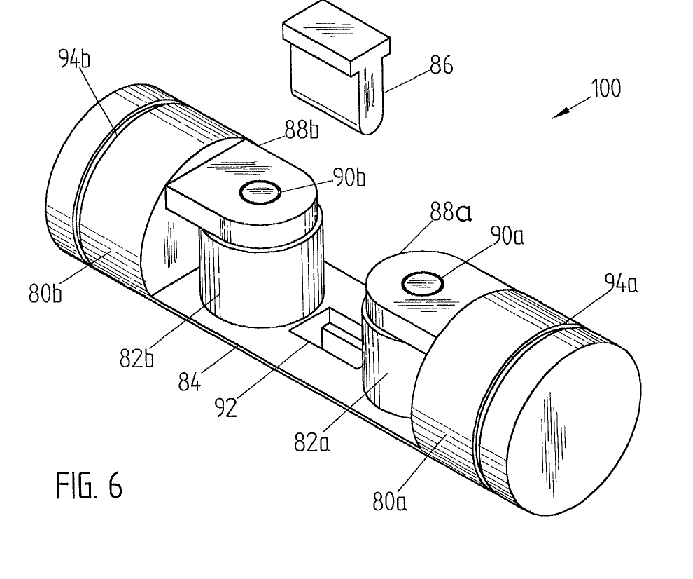

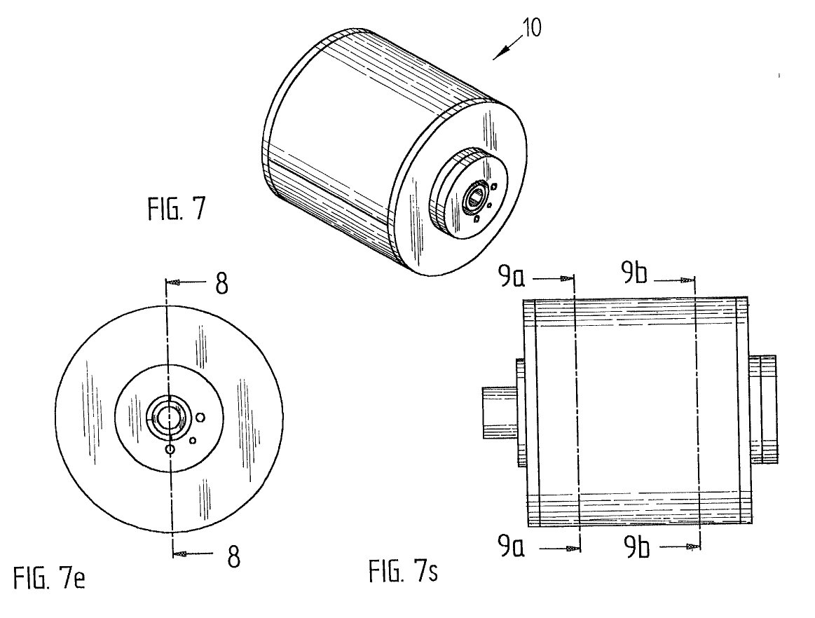

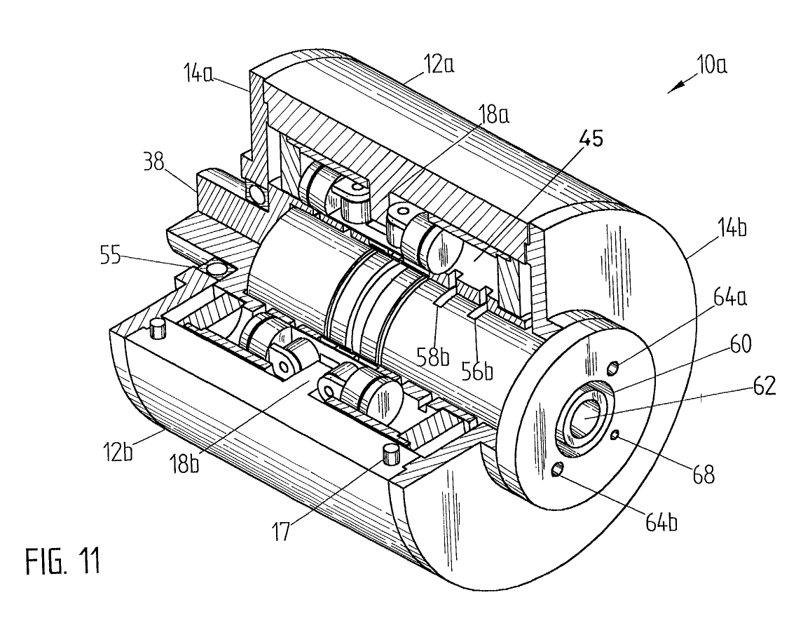

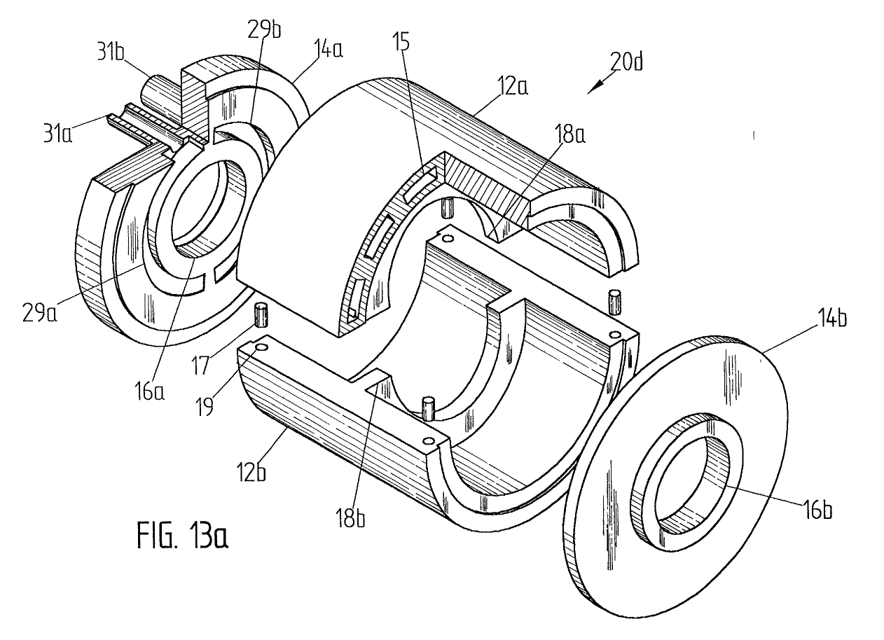

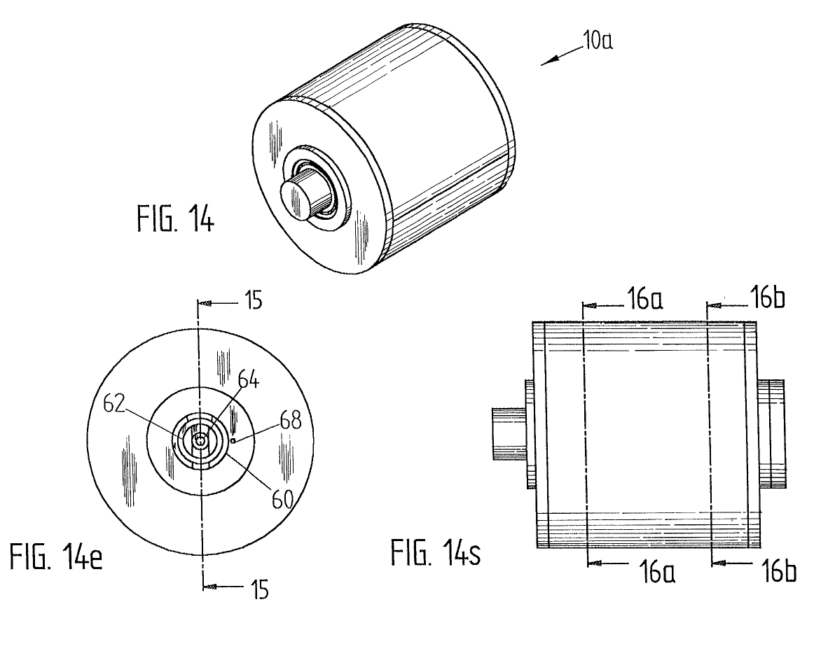

FIGS. 1-9, illustrate the principles of this invention in embodiments configured as a four-cycle internal combustion engine. FIGS. 11-17 illustrate the principles of this invention in embodiments configured as a two-cycle internal combustion engine. A complete reading of the disclosure will lead one skilled in the art will to understand that these same principles can be successfully employed to yield other devices, such as four-cycle and two-cycle pumps, compressors, fluid-driven motors, fluid-driven compressors, expander devices, and internal combustion-driven compressors. These devices are as shown in FIGS. 3a, 4a, 10, 10a-f, 11a, 12, 12a, 18, 19, 20a and. 20b, respectively, comprise a simple modification or replacement of the central stationary member and/or end front plate.

Referring to FIGS. 1-9, a depicted embodiment of the rotary power device 10 of the invention comprises a stationary housing 20 having a generally cylindrical interior. The housing, or external stator 20, preferably comprises a middle portion comprising diagonally split cylindrical halves, comprising an upper half 12a and lower half 12b, forming a generally cylindrical interior that is closed off at its ends by a front end plate 14a, having a central throughhole opening 16a, and a back end plate 14b, having a central throughhole 16b. The diagonally split block can be joined along a line that is a diagonal of the cylindrical block

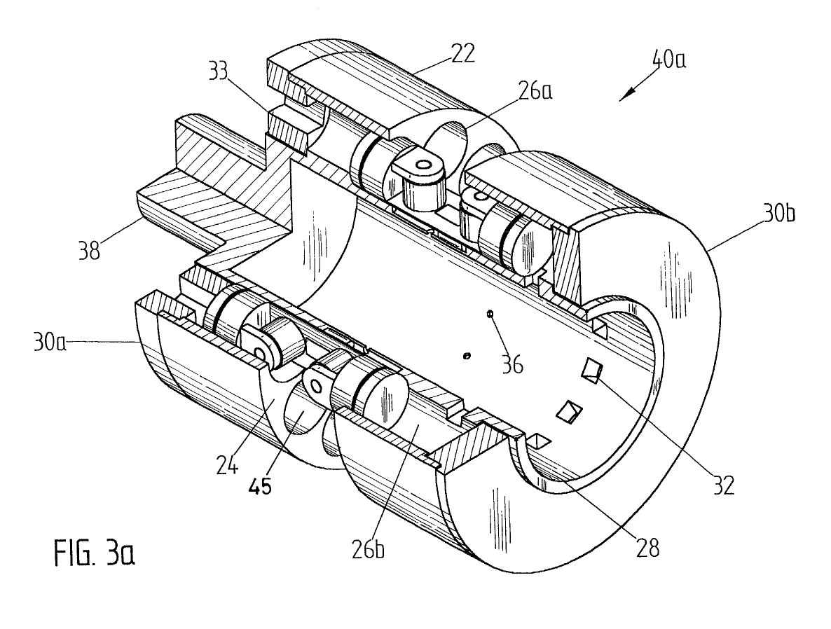

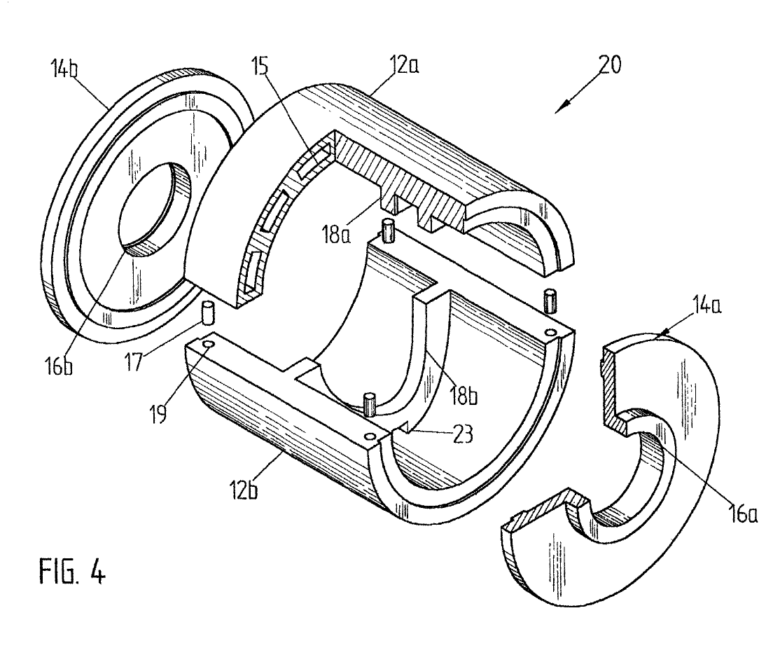

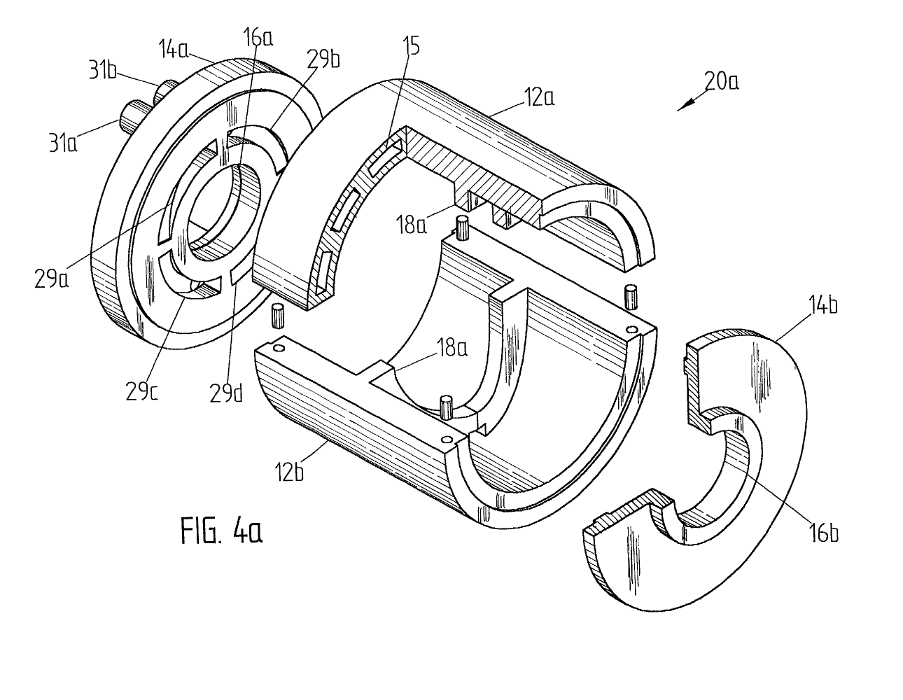

In some embodiments an end plate 14a, as shown in FIG. 4a, may comprise four circular arcuate passages 29a, 29b, 29c and 29d formed into the inner surface of the plate (e.g., by a cutting operation) and connected to respective ports 31a, 31b, 31c, and 31d. These passages may comprise two diagonally opposed fluid intake passages alternated by two diagonally opposed discharge passages. Furthermore, the middle portions of the halves may be aligned by means of alignment pins 17 and corresponding holes 19, and preferably include a multiplicity of cooling passages 15 through which a coolant medium may be circulated by using appropriate intake and discharge ports (not shown). In addition, the lower middle portion 12b preferably includes a passage 23 connected to a port 21 for supplying or withdrawing lubricant, which may serve as an internal cooling fluid in addition to providing a lubricating function. The end plates 14a and 14b are preferably secured to the middle portions 12a and 12b of the stationary housing by tie rods and bolts or other known fastening means (not shown). A generally cylindrical internal stator 50 extends along an axis 13 of the device into the interior of the housing 20 from the end plate central opening 16b and is fixedly attached to the back end plate 14b by bolts or other suitable fastening means (not shown).

A protruding cam is disposed within the cylindrical housing 20 and preferably comprises a pair of diagonally mating portions comprising an upper portion 18a and a lower portion 18b. Each cam portion, as shown in FIG. 4, is preferably formed as an inward surface protrusion extending from an inner surface of a middle portion of the housing 20 and having axially undulating guide track surfaces. In a four-cycle device, the cam surface comprises a first pair of points at which the guide track surface is a maximum distance from the back end plate 14b, and a second pair of points at which the guide track surface is a minimum distance from the back end plate 14b. These minima and maxima are disposed in alternating fashion.

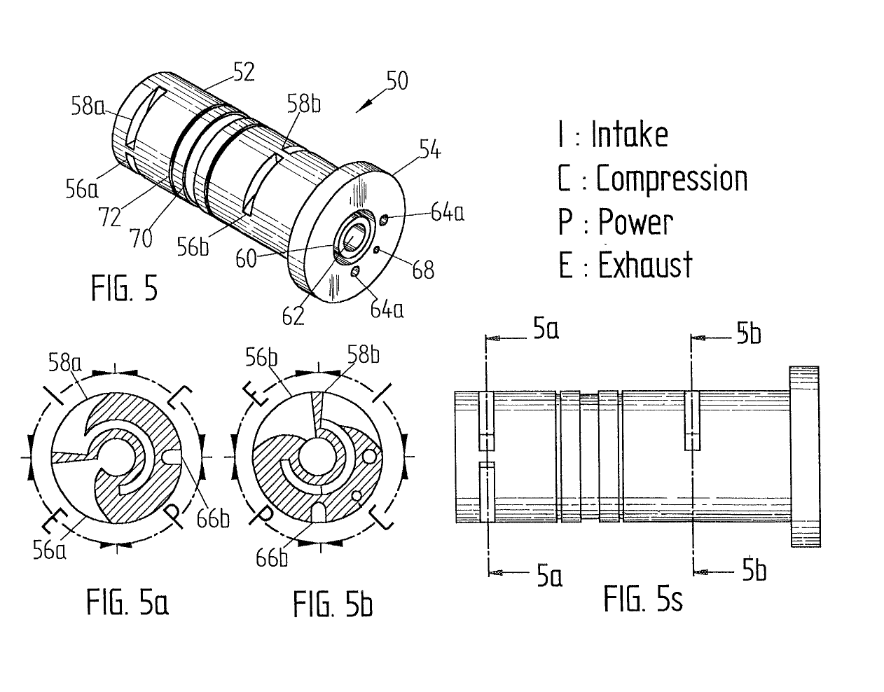

The central internal stator 50, as shown in FIG. 1 and FIG. 5, preferably comprises a cylindrical portion 52 extending coaxially through the interior, and an end flange portion 54 for fixedly attaching the stator to the end back plate 14b. Furthermore, the cylindrical portion 52 is preferably provided with four lateral cutout openings forming one pair of angularly adjacent intake and discharge ports 56a,58a that are axially spaced apart from a similar second pair of angularly adjacent intake and discharge ports 56b, 58b. The two pairs 56a, 58a; 56b, 58b of ports are arranged to have a 90° angular phase shift relative to each other. Each port cutout opening is defined within an angular extension of approximately 90° and has an angularly varying radial depth profile. These lateral openings communicate with axial intake circular channels 62 and discharge annular channel 60. In alternative embodiment (not shown) the intake ports communicate with an annular channel 60 and the discharge ports communicate with a circular discharge channel 60. A first ignition port 66a is disposed approximately diametrically opposite to a corresponding angularly adjacent pair of intake and discharge ports 56a, 58a. A second, similar, ignition port 66b is disposed diametrically opposite to the intake and discharge ports 56b, 58b. These ignition ports 66a and 66b are connected to axial channels 64a and 64b and may comprise means for receiving igniters 76a, 76b, which may comprise spark plugs screwed into a threaded portion of the channel. An annular recess 70 for distribution of lubricant may also be provided in the internal stator portion 52 which is adapted to receive lubricant from port 74 communicating with axial channel 68. Furthermore, two recesses 72 may be provided in order to receive sealing rings (not shown) that would enclose the lubricating recess 70.

The rotor-piston assembly 40 is disposed in the generally annular space formed between the internal stator 50 and the inner wall of the external stator 20. This assembly 40, as shown in FIG. 3, comprises a cylindrical block 22 having a medial annular cutout or recess portion 24 enclosed between a pair of a multiplicity of axially oriented working cylindrical bores 26a and 26b. Each of the working cylinders is parallel to and preferably equidistant from the axis 13 of the device and the working cylinders are preferably spaced at equal angular intervals surrounding the central bore 28. Furthermore, the working cylinders 26a and 26b have inner end opening through the annular recess 24 and outer end openings closeable by cover ring plates 30a and 30b, respectively, that may be retained by fixture means (not shown). The lateral surface of the annular recess 24 may include a multiplicity of axial cam grooves 42 extending axially between two axially opposed working cylinders. The rotor assembly 40 preferably includes an axial shaft 38 fixedly attached to one end of the cylindrical block 22 and rotatably journaled within a bearing means 55 supported in the front end plate 14a. The shaft 38 extends outwardly through the end plate central opening 16a for transmitting output shaft power in versions of the rotary power device that are configured as engines and for receiving an input torque in versions of the rotary power device that are configured as pumps or compressors. In the example depicted in the drawing, there are twelve cylindrical cavities 45 disposed parallel to each other and to the axis of rotation of the shaft 38. Each cylindrical cavity 45 comprises a pair of working cylinder 26a and 26b, each of which has respective radially inward openings 32a and 32b disposed adjacent their respective outer ends and communicating with the central bore 28. Alternatively, as shown in FIG. 3a, the working cylinders 26a adjacent the front plate, instead of having a radially inward end opening, may have an axial end opening through the front ring plate 30a that communicates with channels 29a, 29b, 29c and 29d in the front end plate.

A reciprocating piston assembly 100, as shown in FIGS. 1, 2, 3 and 6, may be axially disposed within the annular recess having opposed cylinder heads, each slidingly engaging respective pistons in respective workings cylinders 26a and 26b. Each piston assembly comprises two opposed cylindrical heads 80a and 80b fixedly coupled by a middle portion 84. The middle portion preferably includes a pair of axially spaced apart roller cam followers 82a and 82b supported by corresponding brackets 88a and 88b and by pins 90a and 90b. These roller cam followers make roller contact with the surfaces of the protruding cam track portions 18a and 18b. The middle portion 84 further includes a slot opening 92 adapted to receive a cam follower pin 86 for slidably engaging the axial cam groove 42 in the rotor annular recess. Ring recesses 94a and 94b may be provided to receive ring seals (not shown) in each piston head.

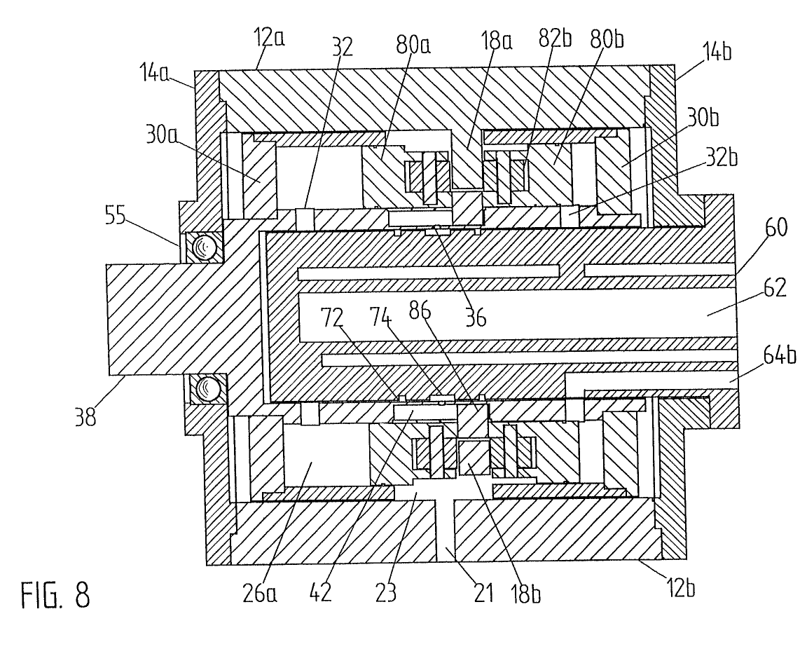

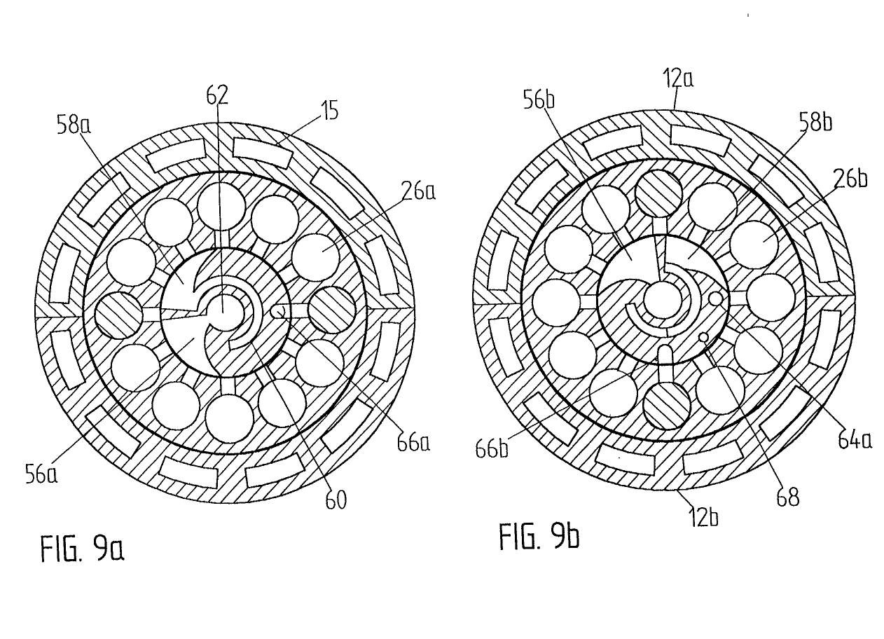

An understanding of the operation of the rotary power device 10 of the invention as a four-cycle internal combustion engine may be gained by reference to the depiction of FIGS. 5a, 5b, 8, 9a, and 9b. This engine may be started by means of a starter motor (not shown) temporarily connected to the shaft 38 to initiate the rotation of the rotor assembly 40. Fluid pressure forces are transmitted from the heads of piston assemblies 100 to respective roller cam followers 82a and 82b that are in rolling contact with the protruding cam track surfaces 18a and 18b to result in a normal reaction force. The tangential components of the normal reaction forces of these contact forces are transmitted to the axial cam groove 42 by means of cam follower pin 86 thereby developing a torque causing the rotation of the rotor assembly. At the same time, the piston assemblies 100 reciprocate in their respective working cylinders 26a and 26b. A step-by-step analysis of the process may begin with by recourse to a limiting position in which one working cylinder, say 26a, of a pair thereof is at its minimum operating volume. This exemplar starting position corresponds to the so-called top dead center (TDC) in a conventional engine. In this arrangement the working cylinder 26a is bounded by one piston head 80a and end cover plate 30a. As the piston element starts moving away from the end wall 30a it uncovers an end opening 32a in the respective cylinder, and an air/fuel mixture charge is drawn into the cylinder from the intake port 56a of the internal stator 50 as the rotor assembly 40 completes the first 90° of angular displacement. At this point the volume reaches a maximum, corresponding to the first bottom dead center (BDC) position in a conventional engine. During the second 90° of angular displacement of the rotor assembly, the piston head 80a starts moving back toward the end wall 30a while the end opening 32a is blocked by the wall portion 52 of the internal stator 50, thereby compressing the air/fuel mixture to a minimum volume, corresponding to the second (TDC) position. At the beginning of the third 90° of angular displacement of the rotor assembly, the end opening 32a aligns itself with ignition port 66a so that a spark from a spark plug 76a can initiate combustion and power expansion. After the expansion the volume reaches its second maximum corresponding to the second (BDC) position in a conventional engine. During the fourth 90° of angular displacement of the rotor assembly, the opening 32a registers with the discharge port 58a as the piston head 80a moves toward the end wall 30a, thereby discharging combustion products as the piston moves towards its second TDC. The other end of the piston assembly 100 performs an identical cycle but with a 90° phase shift. For example, as one of the working cylinders in a cylindrical cavity 45 performs an intake stroke the paired working cylinder performs a compression stroke. As illustrated in FIGS. 9a-9b, the present rotary engine comprises two sets of working cylinders aligned parallel to the axis of the device, wherein each of the sets comprises a circular array and wherein each working cylinder in one set is axially aligned with a respective one of the working cylinders in the other set, each set comprising twelve working cylinders performing, in one revolution of the rotor assembly, the equivalent of twenty-four cylinders in two revolutions of the conventional four-cycle spark ignition engine.

A rotary power device of the invention may be cooled by means of primary and secondary cooling systems. The primary cooling system may comprise a lubricating fluid, such as oil, that is forced through an axial channel 68 in the internal stator, conveyed by radial port 74 to the lubricating annular recess 70, and finally by means of lubricating holes 36 in groove cam 42 to the piston assemblies and rotor external surfaces. The lubricating fluid in the groove cam 42 is forced by the effect of centrifugal forces and friction forces to the protruding cam surfaces, working cylinder internal surfaces and into the clearance gap between the rotor exterior surfaces and inner surfaces of the external stator 20. The lubricating fluid may be removed by means of a port 21 in the lower middle portion 12b of the external casing and then cooled by an external secondary cooling loop (not shown) before returning back to the channel 68. Also, a secondary cooling fluid such as water, may be used by circulating it through jacket cooling passages 15 in the external casing 20. The use of primary and secondary cooling system permits the heat transfer from the primary lubricating cooling fluid to the secondary non-lubricating cooling fluid.

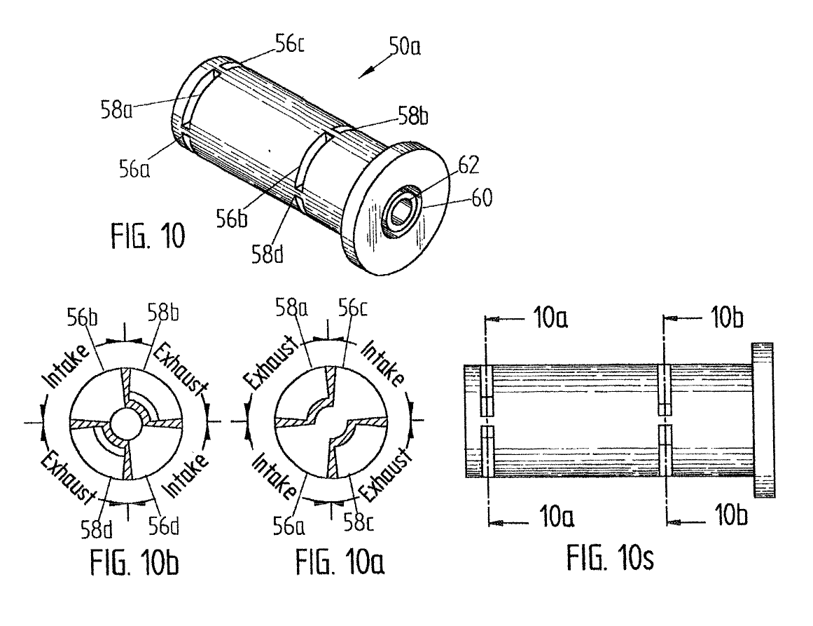

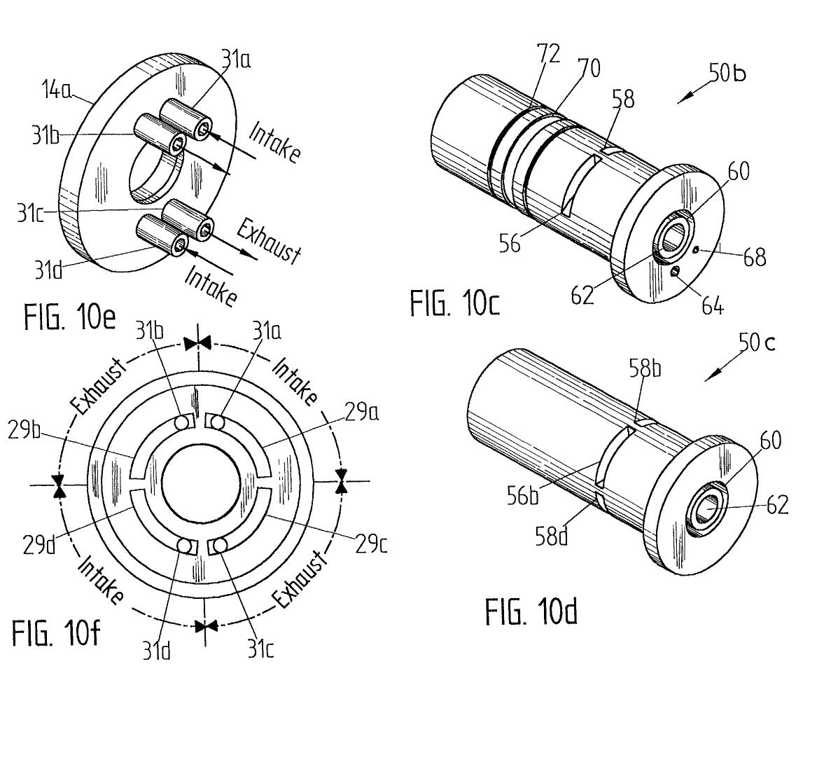

The rotary power device can be easily converted to serve a different purpose other than the internal combustion engine by replacing the internal stator 50 with a modified internal stator. Referring to FIG. 10, 10s, 10a and 10b, a rotary power device employing a modified central stator 50a can function as any one of a motor-driven compressor or pump, a fluid-driven motor, and an expander device operating in four-cycle mode. In this configuration, the internal stator comprises two sets of intake and discharge ports, where each set is defined in one plane transverse to the axis 13 and is axially spaced apart from a second plane that includes the second set. Moreover, each set is in alignment with respective working cylinders end opening 32a and 32b of the rotor assembly. Each set thus comprises two diagonally opposed intake ports alternated by another two diagonally opposed discharge ports. Each set forms a 90° angular displacement relationship with respect to the other set. Each intake and discharge ports is defined within approximately a 90° angular displacement. The four intake ports 56a, 56b, 56c, and 56d communicate with a common central axial intake conduit 62, while the four discharge ports 58a, 58b, 58c, 58d communicate with the annular channel 60. Alternately, (not shown) the four intake ports may communicate with the annular channel 60 while the four discharge ports communicate with the central channel 62.

In the operation of the device depicted in FIGS. 10a-10b, as the rotor assembly completes one revolution, each piston assembly end performs four strokes, which comprise two intake strokes alternated by two discharge strokes. As one end of one piston assembly performs an intake stroke, the other end of the same piston assembly performs a discharge stroke. In functioning as a motor-driven pump or compressor, the rotor assembly is made to rotate by coupling the end shaft to a driving means such as a motor (not shown). The pistons reciprocate in response to the action of cam followers on the protruding cam surfaces, while end openings 32a and 32b of the working cylinders alternately register with intake and discharge ports of the internal stator 50a, thus performing intake and discharge functions. Alternately, the rotary device employing the internal stator shown in FIG. 10 may function as a four-cycle fluid-driven motor or expander device. In such operating mode, a pressurized fluid is received in the axial intake channel 62 and subsequently routed to the operative ends of working cylinders 26a and 26b, thus transmitting an axial force through the piston heads and respective roller cam followers 82a and 82b. The tangential component of the reaction forces between the cam rollers and the protruding cam surfaces 18a and 18b is transmitted through the cam pin 86 in cam groove 42 to impart a torque on the rotor assembly, thus causing the rotation of the assembly. At the same time, reciprocation of the pistons results in discharging the depressurized fluid through channel 60 during the discharge phase of the cycle.

Still another embodiment of the four-stroke rotary power device is one that serves as a four stroke compound internal combustion engine and as a fluid compressor. This is accomplished by replacing the rotor assembly 40 with a modified rotor assembly 40a. The modified rotor assembly comprises a circular array of working cylinders 26b, each of which communicates with the central bore through a respective end opening 32b. The rotor assembly further comprises a second circular array of working cylinders 26a communicating through axial end openings 33 with four circular arc channels 29a, 29b, 29c and 29d embedded in the adjacent front plate 14a of the external stator. Further, in this embodiment, the internal stator 50 is replaced with a modified internal stator 50b, as shown in FIG. 10c. The modified stator 50b comprises one intake port 56, one exhaust port 58 and an ignition port 66, each port communicating with end openings 32b in the circular array 26b of working cylinders. In operation, each working cylinders in the circular array 26b performs four strokes comprising intake, compression, power and discharge strokes as the rotor completes one revolution. In contrast, each working cylinders of the first set 26a function as a fluid compressor executing two fluid intake strokes alternated by two discharge strokes whereby axial end opening 33 alternately communicate with end plate intake passages 29a and 29c and discharge passages 29b and 29d.

In addition to the above applications, the four-stroke rotary power device can be easily converted to serve as a four stroke fluid-driven compressor, pump or pressure exchanger device. In this application the external stator 20 is replaced with modified external stator 20a, as shown in FIG. 4a. Also, the rotor assembly 40 is replaced with the modified rotor assembly 40a of FIG. 3a. The modified rotor assembly comprises set of working cylinders 26b communicating with the central bore through respective end openings 32b. The rotor assembly further comprises a second set of working cylinders 26a communicating through axial end openings 33 with four circular arc channels 29a, 29b, 29c and 29d embedded in the adjacent front plate 14a of the external stator. Also, the internal stator 50 is replaced with internal stator 50c, as shown in FIG. 10d, which comprises two diametrically opposed intake ports 56b and 56d alternated by two diametrically opposed exhaust ports 58b and 58d, each port communicating with end openings 32b in one set 26b of working cylinders. In operation, a highly pressurized fluid is conveyed to one set of working cylinders, say 26b, through an internal stator axial intake channel 62, and is then discharged through an exhaust channel 60. A second weakly pressurized fluid is conveyed to the second set of working cylinders 26a through end plate ports 31a and 31d connected to respective intake channels 29a and 29d and is discharged through channels 29b and 29c connected to respective ports 31b and 31c. An alternative arrangement (not shown) is possible wherein the highly pressurized fluid is conveyed to the first set 26a of working cylinders and the weakly pressurized fluid is conveyed to the other set 26b. The highly pressurized net fluid forces in one set of working cylinders is transmitted through pistons and cam tracks to cause rotation of the rotor and the pressurization of the weakly pressurized fluid in the second set of working cylinders. In this embodiment, each working cylinder perfumes two intake strokes alternated by two exhaust strokes.

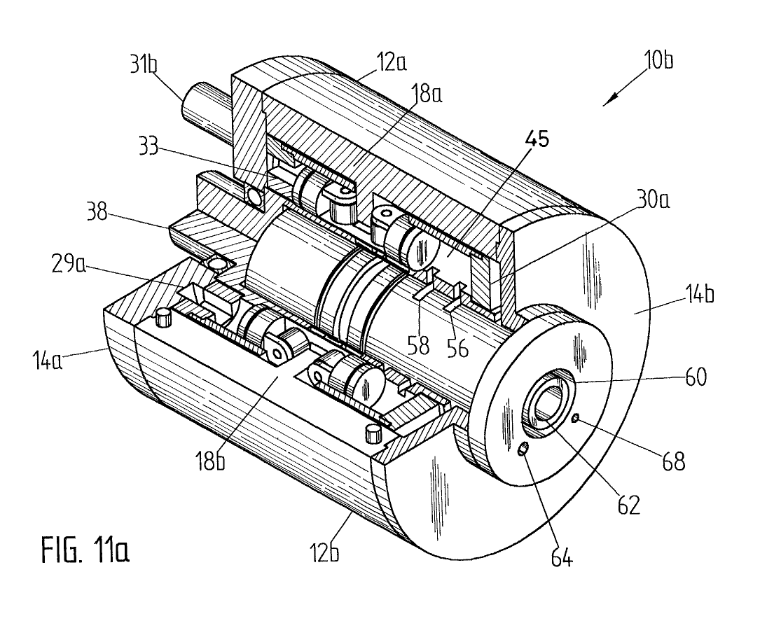

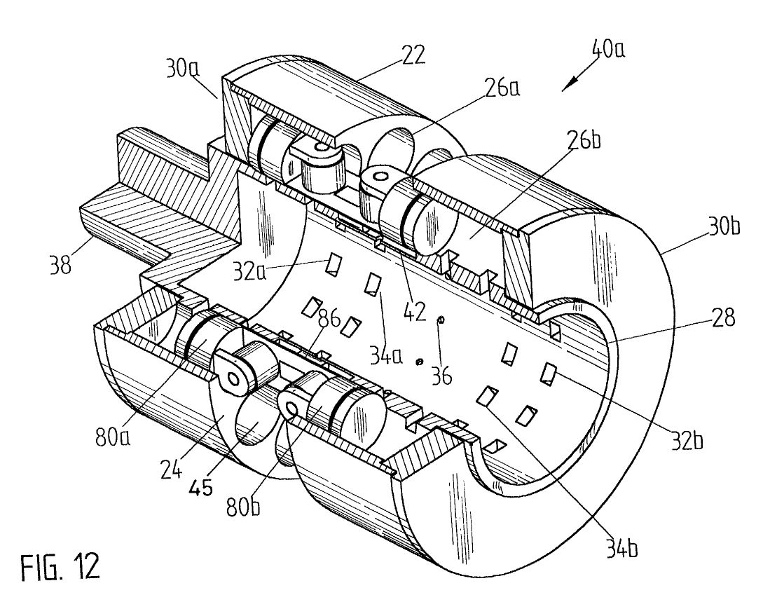

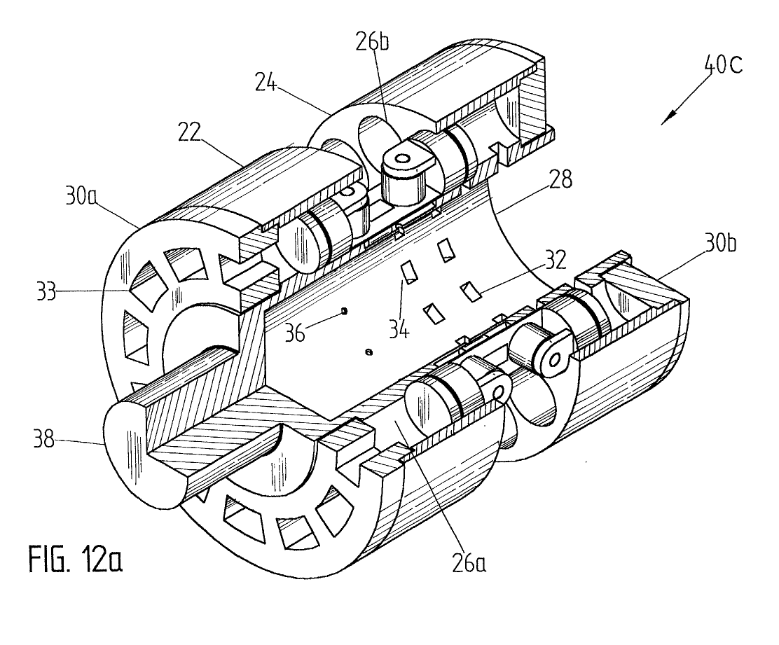

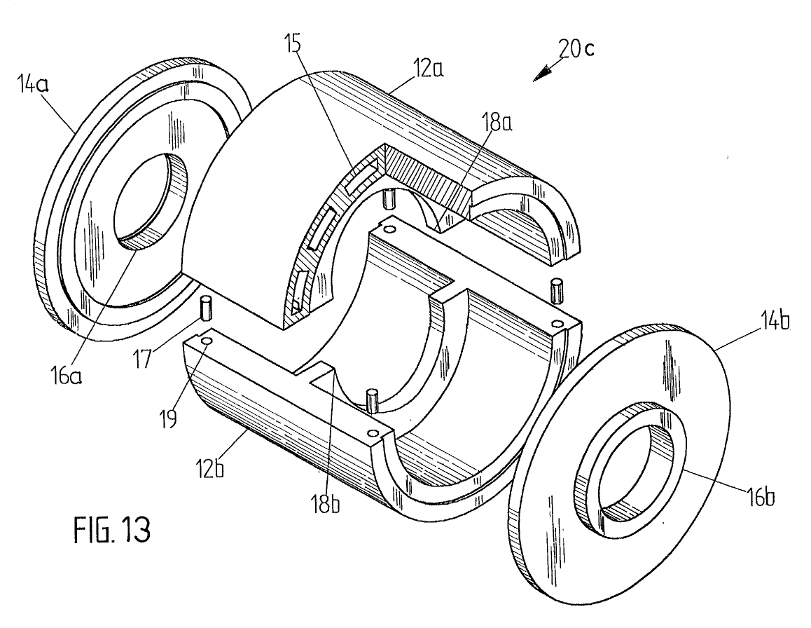

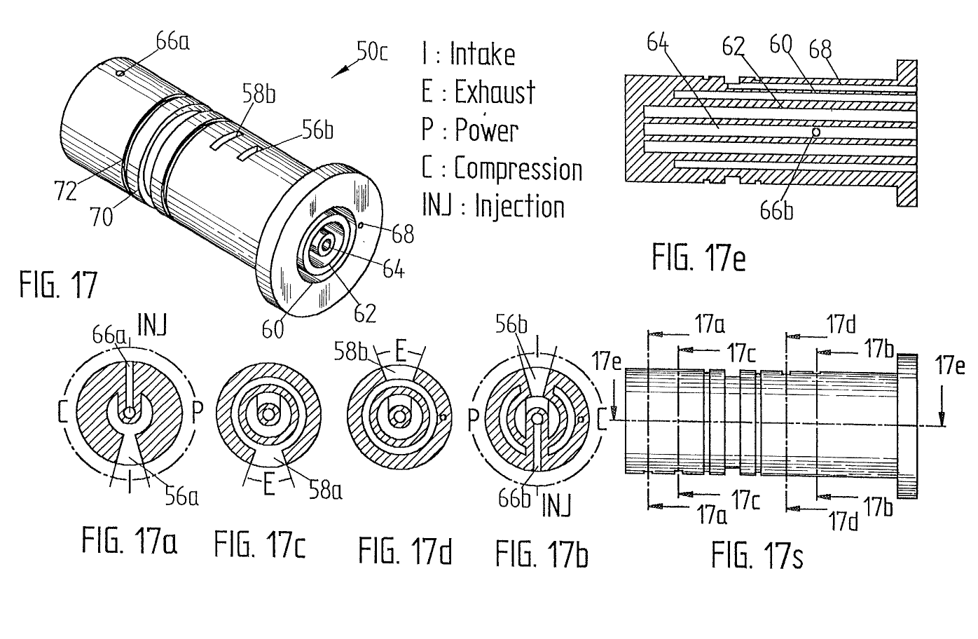

Turning now to FIGS. 11-17, one finds an embodiment of the invention that can operate as a two-cycle internal combustion engine. The transformation of the four-cycle device previously disclosed to a two-cycle rotary internal combustion includes the following modifications. First, the two-cycle protruding cam 18a and 18b of FIG. 4, comprising two minima and two maxima points, is replaced with a one cycle cam track of FIG. 13 comprising one minimum point and one maximum. With this modification each end of a piston assembly performs two strokes when the rotary assembly completes one revolution. Secondly, unlike the four-cycle rotary assembly case in which the end openings 32a and 32b perform both intake and exhaust functions, the two stroke engine of FIG. 11 comprises an additional pair of radially inward medial openings 34a and 34b, as depicted in FIG. 12. These medial openings are used only for the exhaust function, and the radially inward end openings 32a and 32b are used solely for intake. Thirdly, the internal central stator 50 is replaced with a modified central stator 50d shown in FIG. 17.

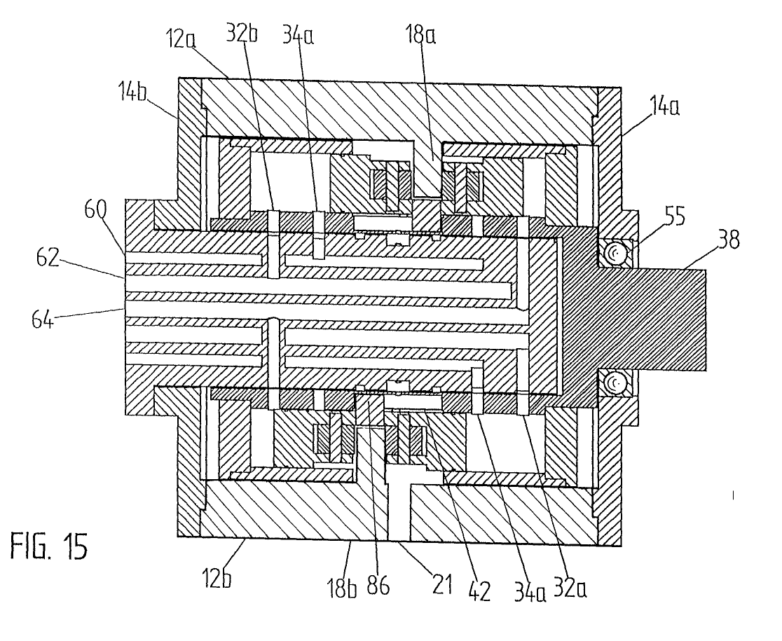

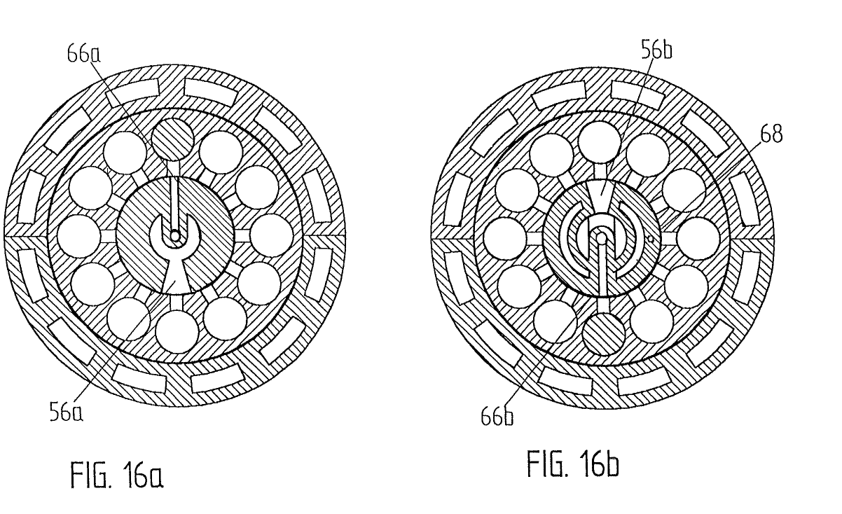

The modified internal central stator 50d as shown in FIG. 17 for a two-cycle internal combustion engine is similar to the internal stator 50 used in the four-cycle engine except for the disposition and angular extent of the intake and exhaust ports. In the two-cycle internal stator 50d, a pair of axially spaced apart intake ports and discharge ports 56a and 58a communicate with corresponding aligned openings 32a and 34a of the first set 26a of working cylinders. Correspondingly, a pair of axially spaced apart intake and discharge ports 56b and 58b communicate with aligned openings 32b and 3b of the second set 26b of working cylinders. To allow for purging of combustion products in this so called scavenging process, the exhaust port is made to have a wider angular displacement so that it overlaps the axially adjacent intake port. Secondly, each pair of axially adjacent intake and discharge ports is disposed at 180° relative to the other pair. In addition, the ignition ports 66a and 66b of the four-cycle engine are replaced with injection ports 66a and 66b in the two-cycle engine. As depicted in FIGS. 16a and 16b, an injection port 66a is disposed diagonally opposite to an intake port 56a, and similarly an injection port 66b is diagonally opposite its associated intake port 56b. Axial channels are provided, as in the four-cycle engine, to connect these ports to the exterior. Intake ports 56a and 56b may communicate with an annular axial channel 62 and exhaust ports 58a and 58b may communicate with an annular channel 60. Alternately, (not shown) the intake ports 56a and 56b may communicate with an annular axial channel 60 and the exhaust ports 58a and 58b may communicate with the annular axial channel 62. A common central axial channel 64 provides injection charges to injection ports 66a and 66b, respectively. The lubricating recess 70 receives lubricating cooling primary fluid through an axial channel 68, and ring seal recesses 72 are adapted to receive ring seals (not shown).

The principle of imparting torque on the rotor is the same as in the four-cycle case. The tangential components of the reaction contact forces between roller cam followers 82a, 82b and the protruding cam surfaces 18a, 18b are transmitted through the cam pin 86 on the groove cam 42 to provide a rotating moment to the rotor. The resulting rotation of the rotor causes the piston assemblies to reciprocate in their respective working cylinders. Because of the one-cycle cam profile, each end of the piston assembly performs two strokes as the rotor moves through a single complete revolution. Each stroke of a piston assembly comprises a predominantly compression stroke at one end and a predominantly power stroke at the opposing end. As shown in FIGS. 17a-17d, the exhaust phase is defined over an angular extent including a portion subsequent to the power stroke and another portion preceding the compression stroke, while the intake phase includes an angular extent overlapped by an exhaust phase.

The operation of a two-cycle power device as an internal combustion engine is illustrated with respect to the internal stator 50d by means of FIGS. 17a through 17d. When one of the working cylinders approaches a minimum volume position, injection and auto-ignition occur through ports 66a and 66b. At the same time, the axially opposite working cylinder is approaching its maximum volume position whereby exhaust followed by purging of products of combustion by portion of the intake air takes place. In the purging operation, the intake port 56a and 56b overlaps with the respective exhaust port 58a and 58b. Because of the larger angular displacement of discharge port, portion of the intake air is used to displace leftover products of combustion in the so-called scavenging process while the remainder is used for compression.

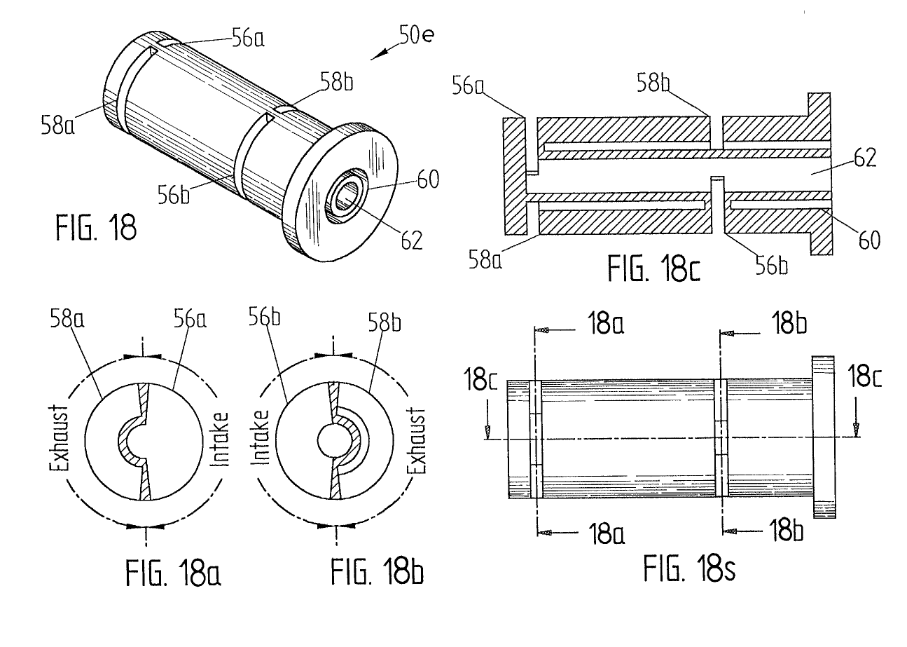

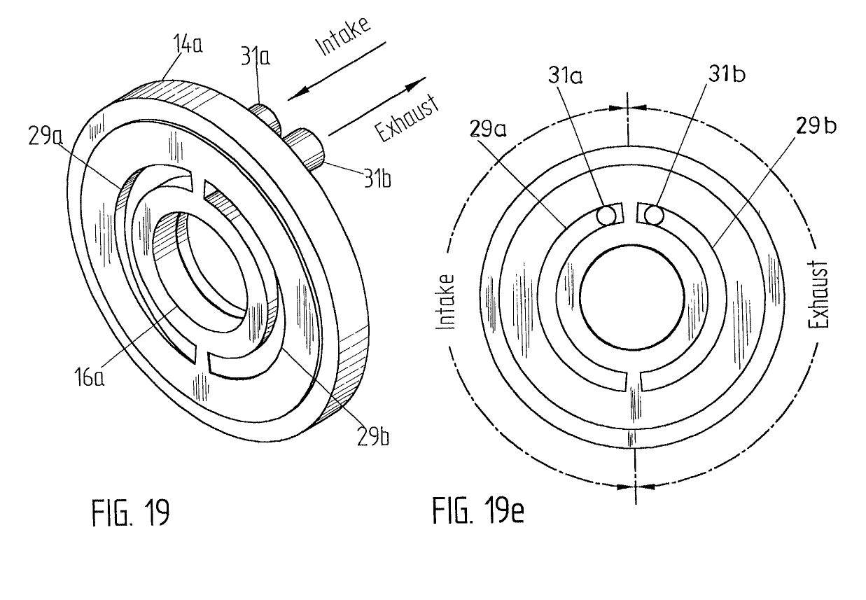

In addition to the internal combustion engine embodiment discussed above, a two-cycle rotary power device of the invention can serve as a pump, compressor, fluid-driven motor or an expander device by replacing the central internal stator member with a stator of the sort shown in FIG. 18. The internal stator 50e depicted in FIGS. 18, 18s, 18a and 18b comprises one pair of axially spaced apart intake ports 56a, 56b communicating with the central intake channel 62, and a second pair of axially spaced apart discharge ports 58a, 58b communicating with an annular discharge channel 60. Alternatively, (not shown) the internal stator 50d may comprise one pair of axially displaced intake ports 56a, 56b communicating with an annular intake channel 60, and a second pair of axially displaced discharge ports 58a, 58b communicating with a central discharge channel 62. Each port is defined within 180° of angular displacement, and each angularly adjacent pair of intake and discharge ports forms a 180° phase angular relationship with respect to the other axially displaced pair. In functioning as a pump or compressor, the rotor assembly is made to rotate by coupling the end shaft 38 to a driving means such as a motor (not shown). The piston assemblies, in response to the action of roller cam followers on protruding cam surfaces, reciprocate while openings 32a and 32b in respective working cylinders alternatively register with corresponding intake ports (56a, 56b) and discharge ports (58a, 58b) of the internal stator 50e, thus performing intake and discharge functions. Each time the rotor completes a 180° angular displacement, each piston assembly completes one stroke, performing a simultaneous intake stroke in one circular array of working cylinders and a discharge stroke in the other array of working cylinders. In functioning as a fluid-driven motor, pressurized fluid received in the axial intake channel 62 is routed to respective ends of working cylinders to cause the reciprocation of the pistons assemblies 100 in respective working cylinders. At the same time, the action of the roller cam followers 82a and 82b on the protruding cam surfaces 18a, 18b imparts a torque on the rotor assembly. In the process, potion of the fluid pressure energy is converted into mechanical rotational energy through the shaft and another portion remains as residual energy in the discharging fluid.

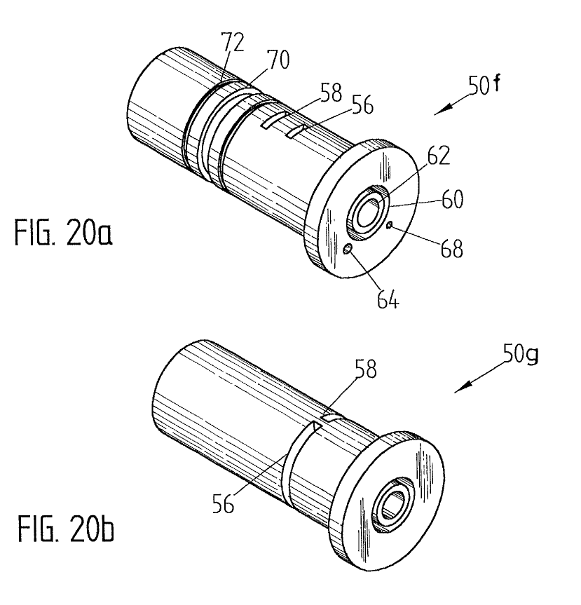

Still another embodiment of the present invention is a rotary power device that can serve as a two-cycle compound internal combustion engine as shown in FIGS. 11a and 12a. In this embodiment a first set of working cylinders 26a communicates with the exterior though axial end opening 33 within the working cylinders. Each end opening 33 alternately communicates with semicircular intake and discharge channels 29a and 29b. These channels are cut into the inner face of the front plate 14a, and each channel has a respective intake and discharge port 31a and 31b. The second set of working cylinders 26b communicates with the internal stator 50f, as shown in FIG. 20a, through radial openings 32, 34 and functions as a two-cycle internal combustion engine while the first set of working cylinders 26a serve as a two-cycle compressor.

Alternatively, the above device can serve as a two-cycle fluid-driven compressor by replacement of the internal stator 50f with another internal stator 50g shown in FIG. 20b. In this case, a first array of working cylinders 26a communicates with the exterior though axial end opening 33 within the working cylinders. Each end opening 33 alternately communicates with semicircular intake and discharge channels 29a and 29b. The second array of working cylinders 26b comprises respective end radial openings 32 that alternately register with an intake port 56 and a discharge port 58 of the internal stator 50g. In functioning as a fluid-driven compressor, a higher pressure fluid supplied to one set of working cylinders may be used to compress or pump a second fluid of lower pressure supplied to the second set of working cylinders.

As will be understood by those skilled in the art, various embodiments other than those described in detail in the specification are possible without departing from the scope of the invention will occur to those skilled in the art. It is, therefore, to be understood that the invention is to be limited only by the appended claims.

1) An axial piston rotary power device comprising a stator portion and a rotor portion, the rotor portion comprising a rotatable shaft extending along an axis of the device,
the stator comprising:
an external stator portion defining a generally cylindrical interior; the external stator portion comprising a middle portion, a back plate portion forming one of two ends of the generally cylindrical interiors and a front plate portion forming the second end of the generally cylindrical interior, the front plate portion having a central throughhole within which the rotatable shaft is journaled;
a cylindrical internal stator portion projecting from the back plate portion into the cylindrical interior along the axis of the device so as to define an annular space extending between the internal and external stator portions, the internal stator portion having a plurality of passageways formed therein, each of the passes comprising a channel parallel to the axis, at least two of the channels communicating with at least one respective radial port formed in the internal stator portion at a respective selected axial position; and
an axially undulating guide surface extending into the annular space from the middle portion of the external stator portion;
the rotor portion further comprising:
a cylindrical block fixedly attached to the shaft, the block rotatable within the annular space between the internal stator portion and the external stator portion, the block comprising a medial annular recess for receiving the axially undulating guide surface, the block comprising a central cylindrical bore for receiving the internal stator, the block further comprising a predetermined number of cylindrical cavities parallel to the axis of the device and spaced apart therefrom by a single selected radial distance, each cavity comprising an axially spaced pair of working cylinders, each working cylinder having a respective medial end communicating with the annular recess and a respective closeable outer end adjacent a respective one of the front plate and back plate portions of the external stator portion, at least one working cylinder in each pair thereof having a radially inwardly directed end opening adjacent the respective outer end thereof, each of the end openings communicating with the central cylindrical bore at a selected axial position; and
the predetermined number of piston assemblies, each piston assembly slidably received in a respective one of the cylindrical cavities; each piston assembly having a piston head at each of two ends thereof and a middle portion extending between the two piston heads, each piston assembly portion comprising at least one respective pair of rotatable roller cam followers for following the axially undulating cam track surface, each piston assembly further comprising a respective cam follower pin for slidably engaging a respective axial groove formed in a wall of the respective cylindrical cavity.

2) The axial piston rotary power device of claim 1 wherein the axially undulating guide surface comprises a protruding portion of an inner surface of the middle portion of the external stator.

3) The axial piston rotary power device of claim 1 wherein the axially undulating guide surface comprises two separate portions attached to each other along a line extending diagonally across the cylindrical block.

4) The axial piston rotary power device of claim 1 wherein:
the axially undulating cam surface comprises a first pair of points at which the surface is a maximum distance from the back plate and a second pair of points at which the surface is a minimum distance therefrom;
the first of each pair of working cylinders has a respective first radially inwardly directed end opening adjacent a respective outer end of the respective first cylinder, each of the first end openings communicating with the central cylindrical bore at a first selected axial position;
the second of each pair of working cylinders has a respective second radially inwardly directed end opening adjacent a respective outer end of the respective second cylinder, each of the second end openings communicating with the central cylindrical bore at a second selected axial position;
the plurality of passageways comprises at least four passageways comprising
at least one inlet passageway comprising at least two inlet ports, each of the first and second end openings communicating exactly once with one of the two inlet ports during the course of each rotation of the block;
at least one exhaust passageway comprising at least two exhaust ports, each of the first and second end openings communicating exactly once with one of the two exhaust ports during the course of each rotation of the block; and
two ignition passageways, a first of the ignition passageways comprising a first ignition port at the first selected axial position, the first ignition port communicating with each first end opening exactly once during each rotation of the block, the second of the ignition passageways comprising a second ignition port at the second selected axial position, the second ignition port communicating with each second end opening exactly once during each rotation of the block, wherein each of the ignition ports comprises means for receiving a respective igniter;
whereby the axial piston rotary power device is adapted to function as a four-cycle internal combustion engine.

5) The four-cycle rotary power device of claim 4 wherein the number of passageways comprises exactly one intake passageway and exactly one exhaust passageway, one of the intake and exhaust passageways comprising an axial channel, the other of the intake and the exhaust passageways comprising an annular channel disposed about the axial channel.

6) The four-cycle rotary power device of claim 4 wherein the means for receiving an igniter comprises a threaded region of the respective ignition port.

7) The axial piston rotary power device of claim 1 wherein
the axially undulating guide surface comprises a first pair of points at which the surface is a maximum distance from the back plate and a second pair of points at which the surface is a minimum distance therefrom;
the first of each pair of working cylinders comprises a respective first radially inwardly directed end opening adjacent a respective outer end of the respective first cylinder, each of the first end openings communicating with the central cylindrical bore at a first selected axial position;
the second of each pair of working cylinders has a respective second radially inwardly directed end opening adjacent a respective outer end of the respective second cylinder, each of the second end openings communicating with the central cylindrical bore at a second selected axial position;
the plurality of passageways comprises at least two passageways comprising
an inlet passageway comprising first and second diagonally opposed radial inlet ports at the first selected axial position, each of the first and second radial inlet ports communicating with each first end opening exactly once during each rotation of the block, the inlet passageway further comprising third and fourth diagonally opposed radial inlet ports at the second selected axial position, each of the third and fourth radial inlet ports communicating with each second end opening exactly once during each rotation of the block;
at least one exhaust passageway, comprising first and second diagonally opposed exhaust ports at the first selected axial position, each of the first and second exhaust ports communicating with each first end opening exactly once during each rotation of the block, the at least one exhaust passageway further comprising third and fourth diagonally opposed exhaust ports at the second selected axial position, each of the third and fourth exhaust ports communicating with each second end opening exactly once during each rotation of the block;
whereby the axial piston rotary power device is adapted to function as one of a four-cycle pump, a four-cycle compressor, a four-cycle fluid-driven compressor and a four-cycle fluid-driven motor.

8) The four-cycle rotary power device of claim 7 wherein the passageways comprise one intake passageway and one exhaust passageway, one of the intake and exhaust passageways comprising an axial channel, the other of the intake and the exhaust passageways comprising an annular channel disposed about the axial channel.

9) The axial piston rotary power device of claim 1 wherein
the axially undulating cam surface comprises a first pair of points at which the surface is a maximum distance from the back plate portion and a second pair of points at which the surface is a minimum distance therefrom;
the first of each pair of working cylinders comprises a respective radially inwardly directed end opening adjacent one of the two end plate portions, each of the radially inwardly directed end openings communicating with the central cylindrical bore at the selected axial position;
the second of each pair of working cylinders comprises a respective axial end opening communicating with the second of the two end plate portions;
the plurality of passageways in the internal stator portion comprises:
one inlet passageway comprising a pair of diagonally opposed radial inlet ports, each of the radial inlet ports communicating with each of the radially inwardly directed end openings exactly once during each rotation of the block;
one exhaust passageway comprising a pair of diagonally opposed radial exhaust ports, each of the radial exhaust ports communicating with each of the radially inwardly directed end openings exactly once during each rotation of the block;
one ignition port for receiving an igniter, the ignition port communicating with each radially inwardly directed end opening exactly once during each rotation of the block,
the second end plate portion further comprising:
two diagonally opposed fluid intake passageways, each of which communicates with each of the axial end openings exactly once during each rotation of the block;
two diagonally opposed fluid exhaust passageways, each of which communicates with each axial end opening exactly once during each rotation of the block;
whereby the axial piston rotary power device is adapted to function as a compound four-cycle internal combustion engine driving a fluid compressor.

10) The axial piston rotary device of claim 9 wherein the passageways in the second end plate portion comprise a first and a second diagonally opposed circular arc intake passageway alternated by a third and a fourth diagonally opposed circular arc exhaust passageway, each of the first through fourth circular arc passageways comprising a respective groove formed in the inner face of the second end plate portion, each of the first through fourth circular arc passageways connected to a respective port.

11) The axial piston rotary power device of claim 1 wherein
the axially undulating guide surface comprises a first pair of points at which the surface is a maximum distance from the back plate and a second pair of points at which the surface is a minimum distance therefrom;
a first of each pair of working cylinders comprises a respective radially inwardly directed end opening adjacent a first of the end plate portions, each of the radially directed end openings communicating with the central cylindrical bore at the selected axial position;
the second of each pair of working cylinders comprises a respective axial end opening extending through its closeable outer end, each axial end opening communicating with a passage in the second end plate portion; and
wherein the plurality of passageways in the internal stator portion comprises:
one inlet passageway comprising a pair of diagonally opposed radial inlet ports, each of the inlet ports communicating with each of the radially directed end openings exactly once during each rotation of the block;
one exhaust passageway comprising a pair of diagonally opposed radial exhaust ports, each of the exhaust ports communicating with each of the radially inwardly directed end openings exactly once during each rotation of the block;
wherein the second end plate portion comprises:
two diagonally opposed fluid intake passageways, each fluid intake passageway communicating with each axial end opening exactly once during each rotation of the block; and
two diagonally opposed fluid exhaust passageways, each of the fluid exhaust passageways communicating with each axial end opening exactly once during each rotation of the block;
whereby the axial piston rotary power device is adapted to function as a four-cycle fluid-driven compressor or four-cycle fluid-driven pump.

12) The axial piston rotary device of claim 11 wherein:
the passageways in the second end plate portion of the external stator comprise first and second diagonally opposed circular arc intake passages alternated by third and fourth diagonally opposed circular arc exhaust passages;
each of the circular arc passageways comprises a respective groove formed in an inner face of the second end plate portion of the external stator; and
each circular arc passageway is connected to a respective port.

13) The axial piston rotary power device of claim 1 wherein:
the axially undulating guide surface comprises exactly one point at which the surface is a maximum distance from the back plate portion and exactly one point at which the surface is a minimum distance therefrom;
each of the cylindrical cavities comprises four axially spaced radially inwardly directed openings, each of the openings communicating with the central cylindrical bore at a corresponding one of four selected axial positions, wherein the first and the fourth of the axial positions are respectively adjacent the two end plate portions of the external stator, wherein the second axial position is intermediate the first and the third positions and wherein the third position is intermediate the second and the fourth positions;
the plurality of passageways comprises at least three passageways comprising
at least one air inlet passageway comprising a first radial air inlet port at the first of the four selected axial positions, the first radial air inlet port communicating with the first radial opening in each cylindrical cavity exactly once during each rotation of the block, the at least one air inlet passageway further comprising a second radial air inlet port at the fourth selected axial position, the second radial air inlet port communicating with the fourth of the radial openings in each cylindrical cavity exactly once during each rotation of the block;
at least one exhaust passageway comprising a first exhaust port at the second axial position, the first exhaust port communicating with the second radial opening in each cylindrical cavity exactly once during each rotation of the block, and a second exhaust port at the third selected axial position, the second exhaust port communicating with the third radial opening in each cylindrical cavity exactly once during each rotation of the block; and
at least one fuel injection passageway comprising at least one fuel injection channel and at least two fuel injection ports, a first fuel injection port disposed at the first selected axial position diagonally opposite the first inlet port, the first fuel injection port communicating with each first radial opening exactly once during each rotation of the block, the second of the fuel injection passageways comprising a second fuel injection port disposed at the fourth axial position diagonally opposite the second inlet port, the second fuel injection port communicating with each fourth radial opening exactly once during each rotation of the block;
whereby the axial piston rotary power device is adapted to function as a two-cycle internal combustion engine.

14) The two-cycle rotary power device of claim 13 comprising one intake passageway, one exhaust passageway and one fuel injection passageway, each of the intake and exhaust passageways comprising respective axial channels disposed about the axial fuel injection channel.

15) The axial piston rotary power device of claim 1 wherein:
the axially undulating guide surface comprises exactly one point at which the surface is a maximum distance from the back plate portion and exactly one point at which the surface is a minimum distance therefrom;
each working cylinders in each pair thereof comprises a respective radially inwardly directed opening adjacent a respective outer end thereof, each of the radially inwardly directed openings communicating with the central cylindrical bore at a respective one of a first and a second selected axial positions;
the plurality of passageways comprises at least two passageways comprising
at least one inlet passageway comprising a first radial inlet port at the first selected axial position, the first radial inlet port communicating with the respective radially inwardly directed opening in a first of each pair of working cylinders exactly once during each rotation of the block, the at least one inlet passageway further comprising a second radial inlet port at the second selected axial position, the second radial inlet port communicating with the respective radially inwardly directed opening in the second of each pair of working cylinders exactly once during each rotation of the block;
at least one exhaust passageway, comprising a first exhaust port at the first selected axial position, the first exhaust port communicating with the respective radially directed opening in each of the first of each pair of working cylinders exactly once during each rotation of the block, the at least one exhaust passageway further comprising a second exhaust port at the second selected axial position, the second exhaust port communicating with the respective radially directed opening in each of the second of each pair of working cylinders exactly once during each rotation of the block;
whereby the axial piston rotary power device is adapted to function as one of a two-cycle pump, a two-cycle compressor, and a two-cycle fluid-driven motor.

16) the two-cycle rotary power device of claim 15 comprising a single intake passageway and a single exhaust passageway, one of the intake and exhaust passageways comprising an axial channel, the other of the intake and the exhaust passageways comprising an annular channel disposed about the axial channel.

17) The axial piston rotary power device of claim 1 wherein:
the axially undulating guide surface comprises exactly one point at which the surface is a maximum distance from the back plate and exactly one point at which the surface is a minimum distance therefrom;
the first of each pair of working cylinders comprises a respective first radially inwardly directed end opening adjacent the outer end thereof, each of the first radially inwardly directed openings communicating with the central cylindrical bore at a first selected axial position;
the first of each pair of working cylinders further comprises a respective second radially inwardly directed opening axially spaced apart from the respective first radially inwardly directed end opening, wherein each of the second radially inwardly directed end openings communicates with the central cylindrical bore at a second selected axial position more distal from a first of the two end plate portions than is the first selected axial position;
the second of each pair of working cylinders comprises a respective axial end opening extending through the closeable outer end thereof, each of the axial end openings communicating with at least the second of the two end plate portions of the external stator;
the passageways in the internal stator portion comprising:
one air inlet passageway comprising a first radial air inlet port at the first selected axial position, the first radial air inlet port communicating with each of the first radially inwardly directed openings exactly once during each rotation of the block,
one exhaust passageway comprising a first exhaust port at the second selected axial position, the first exhaust port communicating with each of the second radially inwardly directed openings exactly once during each rotation of the block;
one fuel injection passageway comprising a fuel injection port disposed at the first selected axial position diagonally opposite the first inlet port, said injection port communicating with each of the first radial inwardly directed openings exactly once during each rotation of the block,
the second end plate portion further comprising:
a fluid intake passageway communicating with each axial end opening exactly once during each rotation of the block; and
a fluid exhaust passageway communicating with each axial end opening exactly once during each rotation of the block;
whereby the axial piston rotary power device is adapted to function as a compound two-cycle internal combustion engine and fluid compressor.

18) The axial piston rotary device of claim 17 wherein the fluid intake and fluid exhaust passageways comprise semicircular grooves formed in an inner face of the second end plate portion of the external stator.

19) The axial piston rotary power device of claim 1 wherein
the axially undulating guide surface comprises exactly one point at which the surface is a maximum distance from the back plate and exactly one point at which the surface is a minimum distance therefrom;
the first of each pair of working cylinders comprises a respective radially inwardly directed opening adjacent a first of the two end plate portions of the external stator, each of the radially inwardly directed openings communicating with the central cylindrical bore at a selected axial position;
the second of each pair of working cylinders comprises a respective axial end opening extending through the closeable outer end thereof, each axial end opening communicating with the second end plate portion of the external stator;
the plurality of passageways in the internal stator portion comprises:
at least one inlet passageway comprising a radial inlet port at the selected axial position, the radial inlet port communicating with each of the radially inwardly directed openings exactly once during each rotation of the block,
at least one exhaust passageway comprising an exhaust port at the selected axial position, the exhaust port communicating with each of the radially inwardly directed openings exactly once during each rotation of the block;
the second end plate portion further comprising:
at least one fluid intake passageway communicating with each of the axial end openings exactly once during each rotation of the block; and
at least one fluid exhaust passageway communicating with each of the axial end openings exactly once during each rotation of the block;
whereby the axial piston rotary power device is adapted to function as one of a two-cycle fluid-driven compressor and two-cycle fluid-driven pump.

20) The axial piston rotary device of claim 19 wherein each of the fluid intake and fluid exhaust passageways comprises a semicircular groove formed in the inner face of the second end plate portion of the external stator.

21) The rotary power device of claim 1 wherein the internal stator portion further comprises at least one axial lubrication passageway for supplying lubricant fluid to a clearance space between the central stator portion and the block.

22) The rotary power device of claim 1 wherein the external stator portion comprises at least one passageway for supplying lubricant fluid to and for withdrawing lubricant fluid from the annular rotor recess.

23) A four-cycle internal combustion engine having an output shaft fixedly attached to a cylindrical block rotatable about an axis of the shaft and received within an external portion of a stator, the external portion of the stator having an axially undulating guide surface fixed thereto, the axially undulating guide surface comprising a first pair of points at which the surface is a maximum axial distance from a first selected axial position and a second pair of points at which the surface is a minimum axial distance from the first selected axial position;
the cylindrical block comprising:
a central cylindrical bore extending through the block along an axis of the shaft;
a medial annular recess extending through an outer cylindrical wall of the cylindrical block;
a predetermined number of cylindrical cavities parallel to the shaft and disposed at a single radial distance from the axis, each cylindrical cavity comprising a pair of working cylinders axially spaced apart on opposite sides of the medial annular recess; each working cylinder having an inner end proximal the medial annual recess and open thereto, each working cylinder having a closeable outer end distal from the medial annular recess, each of the working cylinders having a respective radially inwardly directed opening adjacent the closeable end thereof, the radially inwardly directed opening of one working cylinder in each pair thereof communicating with the central cylindrical bore at the first selected axial position, the radially inwardly directed opening associated with the second working cylinder in the each pair thereof communicating with the central cylindrical bore at a second selected axial position;
the predetermined number of piston assemblies, each piston assembly slidably received in a respective cylindrical cavity; each piston assembly comprising two axially spaced apart piston heads having a middle portion extending therebetween, each middle portion comprising at least a respective pair of rotatable roller cam followers for following the axially undulating guide surface received in the medial annual recess, the middle portion further comprising a respective cam follower pin for slidably engaging a respective axial groove formed in a wall of the respective cylindrical cavity;
the engine further comprising an internal portion of the stator received in the cylindrical bore of the cylindrical block, the internal portion of the stator having a plurality of passageways formed therein, each of the passageways comprising a channel parallel to the axis of the shaft, each of the channels communicating with at least one respective radial port formed in the internal stator at one of the selected axial positions, at least one of the plurality of passageways comprising an inlet passageway, a second at least one of the plurality of passageways comprising an exhaust passageway, and two of the passageways comprising ignition passageways comprising respective ignition ports, each of the ignition ports comprising means for receiving an igniter therein.

24) The four-cycle internal combustion engine of claim 23 wherein the axially undulating guide surface comprises a protrusion from an inner surface of the external portion of the stator.

25) The four-cycle internal combustion engine of claim 23 wherein the axially undulating guide surface comprises two separate portions attached to each other along a line that is a diagonal of the cylindrical block.

26) The four-cycle internal combustion engine of claim 23 wherein the means for receiving an igniter comprises a threaded portion of each ignition port.

27) A two-cycle internal combustion engine having an output shaft fixedly attached to a cylindrical block rotatable about an axis of the shaft and received within an external portion of a stator having an axially undulating guide surface fixed thereto, the axially undulating guide surface comprising a exactly one point at which the surface is a maximum axial distance from a first selected axial position and exactly one point at which the surface is a minimum axial distance from the first selected axial position;
the cylindrical block comprising:
an outer wall comprising a medial annular recess for receiving the axially undulating guide surface;
a central cylindrical bore for receiving an internal portion of the stator, the central cylindrical bore extending through the block along the axis;
a predetermined number of cylindrical cavities parallel to the shaft and disposed at a single radial distance from the axis, each cylindrical cavity further comprising a pair of working cylinders axially spaced apart on opposite sides of the medial annular recess; each working cylinder having an inner end proximal the medial annual recess and open thereto, each working cylinder having a closeable outer end distal from the medial annular recess, each of the working cylinders having a respective radially inwardly directed outer end opening adjacent the closeable end thereof, the outer end opening of a first working cylinder in each pair thereof communicating with the central cylindrical bore at the first selected axial position, the outer end opening associated with the second working cylinder in the each pair thereof communicating with the central cylindrical bore at a second selected axial position; each of the working cylinders further having a respective radially inwardly directed medial end opening adjacent the inner end thereof, the respective medial end opening of the first working cylinder in each pair thereof communicating with the central cylindrical bore at a third selected axial position closer to the first axial position than to the second, the respective medial end opening of the second working cylinder in each pair thereof communicating with the central cylindrical bore at a fourth selected axial position closer to the second axial position than to the first; each of the cylindrical cavities further comprising a respective axial groove extending between its associated pair of working cylinders;
the predetermined number of piston assemblies, each piston assembly slidably received in a respective cylindrical cavity; each piston assembly comprising two axially spaced apart piston heads having a middle portion extending therebetween, each middle portion comprising at least a respective pair of rotatable roller cam followers for following the axially undulating guide surface received in the medial annual recess, the middle portion further comprising a respective cam follower pin for slidably engaging a respective axial groove formed in a wall of the respective cylindrical cavity;
wherein the engine further comprises:
a plurality of passageways formed in the internal stator, each of the passageways comprising a channel parallel to the axis of the shaft, each of the channels communicating with at least one respective radial port formed in the internal stator at one of the selected axial positions, at least one of the plurality of passageways comprising an inlet passageway, a second at least one of the plurality of passageways comprising an exhaust passageway, and at least one of the plurality of passageways comprising a fuel injection passageway.

28) The two-cycle internal combustion engine of claim 27 wherein the axially undulating protruding guide surface comprises a protrusion extending from an inner surface of a middle portion of the external portion of the stator.

29) The two-cycle internal combustion engine of claim 27 wherein the axially undulating guide surface is comprised of two separate portions joined along a line that is a diagonal of the cylindrical block.

30) An axial piston rotary power device operable as one of a compressor and a pump, the device having an input shaft fixedly attached to a cylindrical block rotatable about an axis of the shaft within an external portion of a stator, the external portion of the stator comprising a middle portion having a generally cylindrical interior and two end plate portions spaced apart by the middle portion,
wherein the cylindrical block comprises:
an outer wall comprising a medial annular recess for receiving an axially undulating guide surface portion of the external portion of the stator and a central cylindrical bore for receiving an internal stator portion of the stator, the central cylindrical bore extending through the block along an axis of the shaft;
a predetermined number of cylindrical cavities parallel to the shaft and disposed at a single radial distance from the axis thereof, each cavity comprising a pair of working cylinders axially spaced apart on opposite sides of the medial annular recess, each working cylinder having an inner end proximal the medial annual recess and open thereto, each working cylinder having a closeable outer end distal from the medial annular recess, each of the working cylinders having a respective radially inwardly directed opening adjacent the closeable end thereof, the respective radially inwardly directed opening of one working cylinder in each pair thereof communicating with the central cylindrical bore at a first selected axial position, the respective radially inwardly directed opening associated with the second working cylinder in the each pair thereof communicating with the central cylindrical bore at a second selected axial position;
the predetermined number of piston assemblies, each piston assembly slidably received in a respective cylindrical cavity; each piston assembly comprising two axially spaced apart piston heads having a piston middle portion extending therebetween, each piston middle portion comprising at least a respective pair of rotatable roller cam followers for following the axially undulating guide surface received in the medial annual recess, each piston middle portion further comprising a respective cam follower pin for slidably engaging a respective axial groove formed in a wall of the respective cylindrical cavity;
wherein the compressor further comprises:
a plurality of passageways formed in the internal stator portion, each of the passageways comprising a channel parallel to the axis of the shaft, each of the channels communicating with at least one respective radial port formed in the internal stator at one of the selected axial positions, at least one of the plurality of passageways comprising an inlet passageway, a second at least one of the plurality of passageways comprising an exhaust passageway; and
wherein the axially undulating guide surface has a selected number, equal to or greater than one, of points at which the surface is a maximum axial distance from the first selected axial position and the selected number of points at which the surface is a minimum axial distance from the first selected axial position.
